(19) United States
(12) Patent Application Publication
(10) Pub. No.: US 2022/0239673 A1
(43) Pub. Date: Jul. 28, 2022

(54) SYSTEM AND METHOD FOR DIFFERENTIATING BETWEEN HUMAN AND NON-HUMAN ACCESS TO COMPUTING RESOURCES

(71) Applicant: Zscaler, Inc., San Jose, CA (US)

(72) Inventors: Arik KFIR, Kfar-Saba (IL); Hila Paz HERSZFANG, Tel-Aviv (IL)

(21) Appl. No.: 17/159,889

(22) Filed: Jan. 27, 2021

(51) Int. Cl. H04L 29/06; G06N 20/00; G06F 16/23

(52) U.S. Cl. CPC H04L 63/1408; G06F 16/2365; G06N 20/00

(57) ABSTRACT

A system and method for classifying entities accessing computing resources are provided. The method includes identifying, within a received request to access a computing resource, at least one data feature, wherein a data feature is a piece of data included in the request and uniquely identifies an entity sending the request; analyzing each of the at least one identified feature; and classifying, based on the analysis of the at least one identified data feature, the entity sending the request as any one of: a human, and a non-human.

### TECHNICAL FIELD

The present disclosure relates generally to cybersecurity access control and, in particular, to systems and methods for differentiating between computing resource access requests originating from human and non-human sources.

### BACKGROUND

As governments, businesses, organizations, and the like, increasingly provide services through web or internet applications, such as online shopping, online bill-pay, and the like, such systems may be increasingly vulnerable to cyber threats. Where computing systems are configured to provide clients with remote access, such systems may be accessed both by human users and by non-human, automated clients. While some automated clients may be harmless, such as applications configured to determine whether a given website is accessible, other clients, such as applications configured to collect sensitive data or otherwise interfere with system functionalities, may be harmful to users, systems, and the like. Further, where automated clients may be harmless on an individual basis, processing large numbers of requests or interactions for such clients may slow or stop online systems, limiting the accessibility of the systems for intended users and restricting platform functionality. Accordingly, solutions which provide for differentiation of human and non-human accounts, and access requests generated thereby, to computing resources may improve the availability and functionality of such resources and systems.

Certain solutions providing for differentiation of human and non-human access primarily include manual review and classification. Where a service provider, operator, or administrator wishes to differentiate between human and non-human access, the provider may manually review access logs to determine access type, content, source, and the like, providing for per-request analysis of the nature of each access request. While such manual review methods may provide for differentiation of human and non-human access, such methods may be untenable where large numbers of requests are received, as a human operator may be incapable of manually reviewing each request. Further, such manual methods fail to provide for real-time or near-real-time differentiation of human and non-human access, as manual review may be time-consuming, limiting the applicability of such manual methods in security and access control contexts. In addition, manual methods may be subject to human classification error, such as mis-classification by human classifiers.

In addition to the described manual methods, various automated solutions provide for differentiation of human and non-human computing resource access. Access control systems may be configured to identify non-human access based on various predefined criteria, such as access request sources, access request timing patterns, access request patterns, and the like. Where access control systems are so-configured, the systems may provide for detection, and mitigation, such as by blocking, of non-human access requests, based on known sources of such requests, known patterns of requests, such as large numbers of requests received in a short time, and the like. However, such solutions fail to provide for differentiation of human access requests from non-human access requests evading the various applied filters, such as those described, limiting the applicability of such solutions to detection of non-human access requests matching known request parameters. In addition, such solutions fail to provide for continuous, adaptive access control, as lists of known non-human access request sources, patterns, and the like, must be regularly updated as new values are discovered.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the terms “some embodiments” or “certain embodiments” may be used herein to refer to a single embodiment or multiple embodiments of the disclosure.

Certain embodiments disclosed herein include a method for classifying entities accessing computing resources. The method comprises identifying, within a received request to access a computing resource, at least one data feature, wherein a data feature is a piece of data included in the request and uniquely identifies an entity sending the request; analyzing each of the at least one identified feature; and classifying, based on the analysis of the at least one identified data feature, the entity sending the request as any one of: a human, and a non-human.

Certain embodiments disclosed herein also include a non-transitory computer readable medium having stored thereon instructions for causing a processing circuitry to execute a process for classifying entities accessing computing resources, the process comprising identifying, within a received request to access a computing resource, at least one data feature, wherein a data feature is a piece of data included in the request and uniquely identifies an entity sending the request; analyzing each of the at least one identified feature; and classifying, based on the analysis of the at least one identified data feature, the entity sending the request as any one of: a human, and a non-human.

In addition, certain embodiments disclosed herein include a system for classifying entities accessing computing resources. The system comprises: a processing circuitry; and a memory, the memory containing instructions that, when executed by the processing circuitry, configure the system to: identify, within a received request to access a computing resource, at least one data feature, wherein a data feature is a piece of data included in the request and uniquely identifies an entity sending the request; analyze each of the at least one identified feature; and classify, based on the analysis of the at least one identified data feature, the entity sending the request as any one of: a human, and a non-human.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram depicting multi-client access to a computing resource, according to an embodiment.

FIG. 2 is a flowchart depicting a method for classifying computing resource access requests, according to an embodiment.

FIG. 3 is a flowchart depicting a method for analyzing resource access requests to predict classifications, according to an embodiment.

FIG. 4 is a hardware block diagram depicting a classifier, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

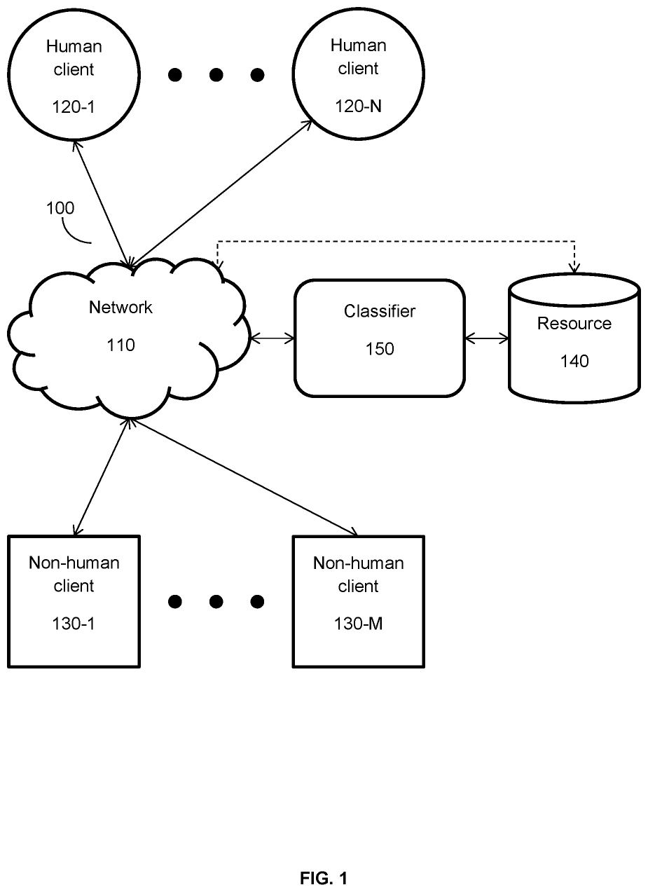

FIG. 1 is an example network diagram 100 depicting multi-client access to a computing resource 140, according to an embodiment. The network diagram 100 includes a network 110, a plurality of human clients, 120-1 through 120-N, where Nϵ [symbol] I.e., where ‘N’ is an integer number greater than one, (hereinafter referred to as “human clients” 120 or “human client” 120), a plurality of non-human clients, 130-1 through 130-M, where Mϵ [symbol] , I.e., where CM′ is an integer number greater than one (hereinafter referred to as “non-human clients” 130 or “non-human client” 130), a computing resource 140, and a classifier 150.

The network 110 provides interconnectivity between the various components of the system. The network 110 may be, but is not limited to, a wireless, cellular, or wired network, a local area network (LAN), a wide area network (WAN), a metro area network (MAN), the Internet, the worldwide web (WWW), similar networks, and any combination thereof. The network may be a full-physical network, including exclusively physical hardware, a fully-virtual network, including only simulated or otherwise virtualized components, or a hybrid physical-virtual network, including both physical and virtualized components.

The human clients 120 are various client devices operated by humans. The human client devices 120 may be user devices such as, as examples and without limitation, personal computers (PCs), smartphones, tablet computers, dedicated kiosks or terminals, other, like, devices, and any combination thereof. Humans may operate the human clients 120 to execute various access interactions with the computing resource 140. Access interactions, executed by the human clients 120 with the computing resource 140, include, without limitation, data exchanges, execution of applications, services, and the like, wherein the human client 120 accesses a data feature or function of the computing resource 140. Examples of access interactions between human clients 120 and the computing resource 140 include, without limitation, sending data to the resource 140, requesting data from the resource 140, other, like, interactions, and any combination thereof. A single human client 120 may execute multiple access interactions, including simultaneously. Further, multiple human clients 120 may each execute one or more interactions, including simultaneously.

The non-human clients 130 are various client devices operated by means other than human interaction, such as by automation, scripting, execution of instructions, and the like, as well as any combination thereof. The non-human clients 130 may be devices including those devices described with respect to the human clients 120, as well as unmanned devices, servers, remote systems, and the like, and any combination thereof. Non-human clients 130 may be configured to execute one or more instructions, the instructions providing for human-free access interaction with the computing resource 140. Access interactions executed by the non-human clients 130 may be similar or identical to those access interactions executed by the human clients, and may further include similar access interactions configured for increased volume, frequency, and the like, as well as any combination thereof. As described with respect to the human clients 120, one or more non-human clients 130 may be configured to execute one or more automated access interactions, including simultaneously.

The computing resource 140 is a device, system, or other, like, resource configured to provide various functionalities in response to access interactions executed by the human clients 120, the non-human clients 130, and the like, as well as any combination thereof. The computing resource 140 may be configured to provide various functionalities including, without limitation, data storage, data processing, device interconnectivity, other, like, functionalities, and any combination thereof. The computing resource 140 may be, as examples and without limitation, a database, a cloud computing server, a timeshare processing server, and the like, as well as any combination thereof. The computing resource 140 may be implemented as one or more physical components or devices, one or more virtual components or devices, or as various combinations of physical and virtual components and devices. Further, the computing resource 140 may be connected to the network 110 directly, indirectly, such as through the classifier 150, or both directly and indirectly, such as via parallel connections.

Although the network diagram 100 described with respect to FIG. 1 includes only one computing resource 140, it may be understood that such a system may include one or more computing resources 140 without loss of generality or departure from the scope of the disclosure.

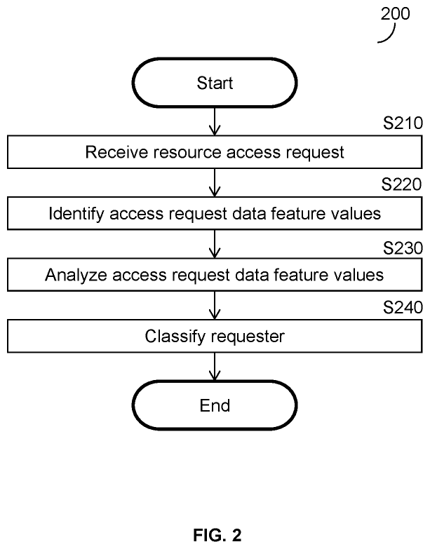

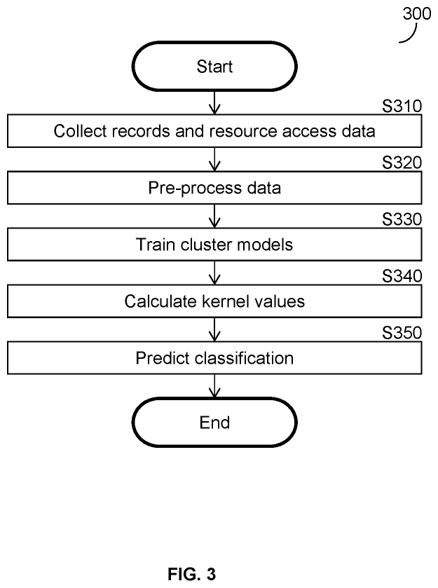

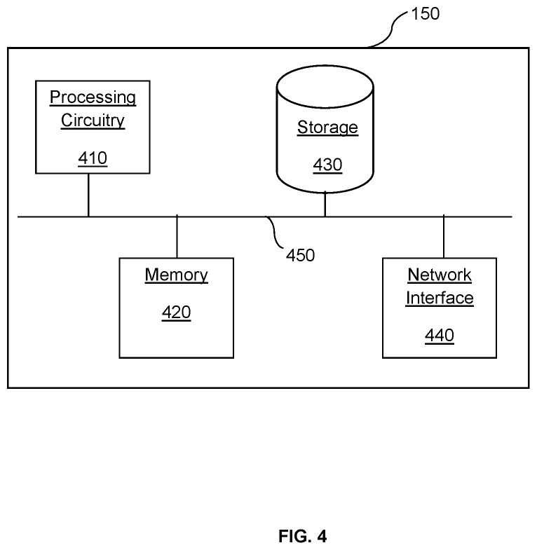

The classifier 150 is a device, system, component, or the like, configured to provide for various functionalities including, without limitation, differentiation of human and non-human access requests. The classifier 150 may be configured to execute one or more instructions, methods, and the like, including, without limitation, the processes described with respect to FIGS. 2 and 3, below, and the like, as well as any combination thereof. The classifier 150 can be also realized as software, such as a software application, a service, a micro-service, and the like. The software is executed over hardware, such as is discussed below with reference to FIG. 4. Further, the classifier 150 may be configured to provide the functionalities described herein by application of one or more machine learning, or similar, techniques, including, without limitation, application of unsupervised machine learning algorithms, and the like, as well as any combination thereof. The classifier 150 may be configured to interconnect the network 110 and the resource 140, providing for filtering and other, like, management of data transmitted between the network 110 and the resource 140, including, without limitation, based on various determinations of human or non-human access request origin.

According to various embodiments, the classifier 150 may be included as a part or component of another element of the network system depicted with respect to FIG. 1, including, without limitation, the network 110, the computing resource 140, other, like, elements, and any combination thereof. The classifier 150 may be implemented as one or more hardware systems, devices, or components, as one or more virtual systems, devices, or components, or as one or more hybrid physical-virtual systems, devices, or components. An example hardware structure for a classifier 150, according to an embodiment, is described with respect to FIG. 4, below.

FIG. 2 is an example flowchart 200 depicting a method for classifying computing resource access requests, according to an embodiment. The method depicted with respect to FIG. 2 may be executed by one or more systems, devices, or components, including, without limitation, the classifier, 150, of FIG. 1, above, and the like, as well as any combination thereof.

At S210, a resource access request is received. A resource access request is a data feature including one or more instructions, commands, and the like, which instructions or commands may configure the receiving computing resource, which may be a resource similar or identical to the resource, 140, of FIG. 1, above, to, as examples and without limitation, return a data feature stored in the computing resource, to update a data feature stored in the computing resource, to return a status indicator describing various data features stored in the computing resource, to execute one or more further commands or instructions, and the like, as well as any combination thereof. The resource access request received at S210 may be received from one or more sources including, without limitation, the human clients, 120, and non-human clients, 130, of FIG. 1, above, other, like, sources, and any combination thereof.

At S220, resource access request data feature values are identified. Resource access request data feature values are the values of data features relevant to the resource access request received at S210. Resource access request data features may include, as examples and without limitation, data features collected during execution of the received resource access request, data features updated during execution of the received resource access request, data features accessed or referenced during the execution of the received resource access request, and the like, as well as any combination thereof. Resource access request data features, and values thereof, may be identified via one or more means including, without limitation, inspection of resource access request contents, inspection of resource access request response contents, inspection of resources called or invoked during the execution of a process specified in the received resource access request, and the like, as well as any combination thereof.

At S230, resource access request data feature values are analyzed. Resource access request data feature values, identified at S220 from the request received at S210, are analyzed to determine whether the received access request was generated or sent by a human client. Analysis at S230 may further include the determination that a resource access request was generated or sent by a non-human client, as well as, in an embodiment, the various error estimations associated with each prediction described herein. Resource access request data features may be analyzed according to one or more methods including, without limitation, the method described with respect to FIG. 3, below, as well as other, like, methods, and any combination thereof.

At S240, the requester, such as a human client or non-human client, as described hereinabove, generating the resource access request, is classified. The resource access request may be classified according to one or more dynamic calculations, based on the results of the analysis at S230. In an embodiment, where the analysis of S230 yields a matching cluster, indicating a likelihood that the request received at S210 was generated or sent by a human or non-human client, classification at S240 may include classifying the requester as “human,” “non-human,” or “unknown.” Classification at S240 may include classifying of the requester as “human” or “non-human,” where the results of the analysis at S230 indicates a likelihood of such a classification, including, in an embodiment, where the indicated likelihood is above a pre-defined threshold. Further, in an embodiment, classification at S240 may include classifying of the requester as “unknown,” where the indicated likelihood is below a predetermined threshold.

FIG. 3 is an example flowchart 300 depicting a method for analyzing resource access requests to predict classifications, according to an embodiment. The method depicted with respect to FIG. 3 may be executed by one or more systems, devices, or components, including, without limitation, the classifier, 150, of FIG. 1, above, and the like, as well as any combination thereof. Further, the system, device, component, or the like, executing the method described with respect to FIG. 3, may be configured to execute the method using one or more machine learning techniques including, without limitation, unsupervised machine learning, and the like, as well as any combination thereof.

At S310, records and resource access data are collected. Records and resource access data includes one or more data features relevant to a received resource access request, where the received resource access request may be a resource access request similar or identical to the resource access request received at S210 of FIG. 2, above. Records and resource access data may include one or more data features such as, without limitation, data features included in the received resource access request, data features specified in the resource access request and stored in the system, device, or component to which the request is directed, data features relevant to the execution of one or more instructions, commands, and the like, specified in the request, the request metadata, and the like, as well as any combination thereof. Records and resource access data, as collected at S310, may be collected from one or more sources including, without limitation, a source device or system, a destination device or system, a network, or component thereof, by which the request is transmitted, results of various analyses of individual or aggregate requests, and any combination thereof. Further, records and resource access data, as collected at S310, may be collected in one or more formats or data types including, as examples and without limitation, characters, strings, integers, vectors, tables, maps, nested structures, and the like, as well as any combination thereof.

Examples of data features included in a request include, without limitation, submitted usernames, passwords, hashed password values, updated values, and the like, as well as any combination thereof. Examples of stored data features include, without limitation, stored records, record descriptors, such as file sizes and permissions, other, like, features, and any combination thereof. Further, examples of features relevant to the execution of instructions include, without limitation, variables used in the execution of calculations, expected instruction execution times, lists of process inputs and outputs, and the like, as well as any combination thereof. In addition, examples of request metadata include, without limitation, request source and destination internet protocol (IP) addresses, request generation time and date stamps, and the like, as well as any combination thereof.

At S320, data is pre-processed. Pre-processing of data at S320 includes the normalization of one or more access request data features collected at S310, providing for the subsequent analysis of such normalized features based on the processes described hereinbelow, as well as other, like, processes. Such normalization may provide for comparative analysis of access requests based only on the requests' contents, rather than the structure and contents of the requests, providing for improved comparison of access requests. Normalization, as may be included in data pre-processing at S320, may include application of one or more normalization methods, algorithms, processes, and the like, as well as any combination thereof, including, without limitation, standardization and scaling of data features to the features' respective mean and standard deviation values and units.

Pre-processing of data at S320 may further include various data clean-up processes such as, as examples and without limitation, adjusting string data values to all-uppercase or all-lowercase values, adjusting numerical values to specified, standard, formats, appending one or more data labels or tags to individual data features or groups of data features, and the like, as well as any combination thereof.

Pre-processing of data at S320 may further include detection of one or more indicators, the indicators indicating generation of the access request by human or non-human sources. Detection of request generation source type at S320 may include analysis of request data features based on one or more criteria including, without limitation, data feature types, contents, and the like, as well as any combination thereof. Where a request is identified as originating from a human or non-human source, the request may be tagged or labeled with one or more descriptors, the descriptors reflecting the same determination. In a first example, where requests are evaluated for human or non-human characteristics based on the contents of a received username data feature and a data feature describing the count of the number of account descriptions associated with the same username, such as user addresses, phone numbers, and the like, pre-processing of data at S320 may include detection of whether a username, included as a data feature of the received access request, includes numbers, where inclusion of numbers may be, according to a pre-defined rule, indicative of request generation by a non-human client.

At S330, cluster models are trained. Clusters are groups of similar objects, grouped according to one or more methods, including, without limitation, application of machine learning (ML) technologies, and the like, as well as any combination thereof, where similarity is determined by collections of data features, such as the data features normalized at S320, while cluster models are models including one or more clusters. For example, data features collected for a clustering job may include, without limitation, usernames, passwords, source IP addresses, and the like. Data features may vary in their values by a maximal threshold, where such maximal thresholds may be defined by one or more means including, without limitation, pre-definition by a user or operator, pre-definition within an ML application, other, like, means, and any combination thereof, and where the in-cluster distance reflects the variance between the values of the cluster members. For example, a cluster model of access requests, including usernames collected from server-side username dictionaries and from received login requests, as well as counts describing the number of account descriptions associated with the same usernames, may include data features, which may be, for example, two-part data features describing usernames and associated account description counts. According to the same example, the data feature values may be varied within the cluster model based on differences between the features' contents, such as the number of spaces in each attributed name field, username, counts of username-associated account details, and the like, as well as any combination thereof. Subsequent analysis of clusters trained at S330, such as at S340, below, may provide for evaluation of one or more cluster kernels, as may be further applicable to the prediction of the status of a single access request, as described hereinbelow.

Training of cluster models at S330 may further include the training of separate human and non-human clusters, for data feature values, such as username values, where such data features are tagged or labeled as indicators toward a human or non-human classification at S320. Further, construction of clusters at S330 may include the construction of clusters relevant to various data features, such as usernames, where both human- and non-human-indicative data features, labeled as described hereinabove, are included in the same cluster model and, within the cluster, labeled so as to indicate whether a given feature has been tagged as human or non-human.

As an example, clusters may be generated based on received access requests, where the received access requests include two data features, such as a feature describing a count of the number of numerals in a username and a feature describing a number of account descriptions associated with the same username. Clusters may be trained by mapping the requests, based on the requests' component features, to a two-dimensional space, wherein a first axis describes the number of numerals in a username, and wherein the second axis describes the number of account details associated with the same username. According to the same example, the model objects to be labeled may be visualized as a collection of points in the same axis, the points representing individual access requests, with the points' placements relating to the requests' respective username numeral counts and username-associated account details counts.

It may be understood that, although the training of clusters and subsequent analyses are described with respect to two-variable access requests evaluated in a two-dimensional scheme, the same descriptions may be likewise applicable to n-dimensional requests evaluated under an n-dimensional scheme, where ‘n’ is an integer greater than one, without loss of generality or departure from the scope of the disclosure.

At S340, kernel values are calculated for each of the clusters. Kernels are vectors of data feature values approximating the center values with minimal distance from the cluster members, or the center values with minimal distance from of various sets of features within a cluster. A cluster model with n clusters has exactly n kernels with a 1-to-1 relationship between kernels and clusters. Kernels may have a dimensionality of one or more, where the dimensionality of a kernel is equivalent to the dimensionality of the access requests constituting the clusters, of which the kernel represents the vector with minimal distance from the cluster members' vectors.

As an example, a cluster may include several two-dimensional access requests, the access requests including data features describing counts of numerals in usernames and counts of account details associated with the same usernames. According to the same example, usernames including non-zero numeral counts may be pre-determined to be non-human usernames and, accordingly, access requests including frequently used usernames may be an indication of a non-human requester. As the access requests included in the dataset include two dimensions, a count of the number of numerals in a username and a count of the number of account details associated with the same username, the kernel or kernels of the cluster may have the same two-dimensional structure, including the same dimensions as the access requests' data features. In the same example, the cluster model may include a human kernel, representing a vector with minimal distance from the cluster of user access requests tagged as “human,” and a non-human kernel, representing a vector with minimal distance from the members of the group of user access requests tagged as “non-human.”

The value of the kernel, as may be relevant to the identification of classification predictions, as described hereinbelow, may be determined according to the following formula:

V(k):=Σⱼ₌₀ⁿ⁻¹k^{j}

According to the above equation, the value of a kernel V(k), is set equal to a summation series, where the series includes adding the individual kernel element values, k^{j}, where j is an integer-based index, initially equal to zero, incremented by steps of one, n−1 times, wherein n represents the dimensionality of the kernel. According to the example provided above, where an access request, and thus, the corresponding kernel, includes a dimensionality of two, as the access request includes a (normalized and processed) count of the number of numerals in a username and a count of the number of account details associated with the same username, the value of the kernel may be determined by adding the count of the number of numerals in the username, and adding the count of the number of associated account details.

Where an access request data feature is known to indicate whether the request is of human or non-human origin, such as the inclusion of numerals in a username, calculation of kernel values may include calculations based on re-mapping of access requests including non-zero username numeral counts. Such a re-mapping, according to the same example, may include multiplying the non-zero username numeral counts by negative one, providing for the determination of a negative kernel value, according to the equation described above, for such access requests including non-zero username numeral counts. According to the same example, a first kernel value may be determined to be positive, as the access requests for which the kernel represents the vector having a minimal distance from the access requests' vectors in the cluster do not include updated negative values, and a second kernel may be determined to be negative, as the access requests for which the kernel represents the vector having a minimal distance from the access requests' vectors in the cluster includes updated negative values.

Following calculation of one or more kernel values, a classification kernel may be identified, where the identity of the classification kernel, representing the vector with minimal distance from the cluster's members' vectors of a group of human-tagged, or, in an embodiment, non-human-tagged, data features, is determined according to the following formula:

Kₕᵤₘₐₙ=max(Kᵢ,key=V(Kᵢ))

According to the above equation, the identity of the human classification kernel, Kₕᵤₘₐₙ, is determined based on the identification of the highest-value kernel representing a vector having a minimum distance from the cluster members' vectors of a cluster of human-tagged access requests. In the above equation, the identity of the human classification kernel, Kₕᵤₘₐₙ, is equal to the identity of the highest-value kernel, max(Kᵢ), where the highest-value kernel is the kernel having the greatest value, represented as key=V(Kᵢ), where the kernel value, V(Kᵢ) is determined as described above. According to the above example, where kernels are evaluated for each human-tagged data feature included in the cluster, the value of each kernel corresponding to a human-tagged data feature may be determined, as described above, and the highest-value kernel may be identified as the human classification kernel.

Further, a second evaluation of a corresponding minimum kernel value may provide for identification of a non-human access origin kernel, where, as described above, access request username numeral count values may be updated by multiplication by negative one, providing for clustering of a group of negative-value access requests and a corresponding negative-valued kernel.

At S350, classifications are predicted. Prediction of classifications at S350 includes the determination of a Euclidean distance between the human-classified kernel, identified as described with respect to S340, and a given, unlabeled data feature. The prediction of an account request classification, such as human or non-human, includes the minimization of such Euclidean distance, where an access request is predicted to be human or non-human based on the kernel closest to the access request in the cluster model. Accordingly, where the Euclidean distance between an access request and a human classification kernel is less than the Euclidean distance between the access request and the non-human classification kernel, the request may be predicted to be of human origin. Conversely, where the Euclidean distance between an access request and a non-human classification kernel is less than the Euclidean distance between the access request and the human classification kernel, the request may be predicted to be of non-human origin. Such a minimization is described with respect to the following formula:

Prediction(r)=Prediction(min(Kᵢ,key=∥Kᵢ−r∥))

In the above equation, determination of whether a given access request, r, is human-generated, is evaluated based on the identity the kernel closest to the access request record. In the above equation, the prediction of whether a record, r, is human-generated or non-human generated, given as Prediction(r), is equal to the prediction of whether a corresponding minimum kernel is a human kernel or a non-human kernel. The corresponding minimum kernel, min(Kᵢ), is the kernel, of the relevant kernels, for which the Euclidean distance between the kernel and the record, r, is minimized. The evaluation of a minimum kernel based on the Euclidean distance is denoted as key=∥Kᵢ−r∥, where the Euclidean distance is evaluated as described below. As an example, the human or non-human status of a record, r, is set equal to the human or non-human status of the minimum-value kernel, evaluated, as described, with respect to the record, r, where the human or non-human status of the minimum-value kernel is known. The same equation may be likewise applicable to the prediction of non-human origin of an access request by substituting the non-human classification kernel value for the human classification kernel value. The absolute value of the distance, ∥Kₕᵤₘₐₙ−r∥ is calculated by the Euclidean distance formula:

∥Kₕᵤₘₐₙ−r∥=\sqrt{(kₕᵤₘₐₙ⁰−r⁰)²+ . . . +(kₕᵤₘₐₙⁿ⁻¹−rⁿ⁻¹)²}

In the above equation, the absolute value of the distance between the human classifier kernel and a given unlabeled access request, the distance given as ∥Kₕᵤₘₐₙ−r∥, is the square root of the sum of the squares of the human classification kernel's n^{th}-dimension value, less the unlabeled access request's n^{th}-dimension value for each value between zero and n, where, as above, n is the dimensionality of the access request, the human classification kernel, or both. As above, the equation described may be made applicable to the determination of the absolute value of the distance between the non-human classification kernel and the unlabeled access request by substituting the non-human classification kernel value for the human classification kernel value. Accordingly, the Euclidean distance between an unlabeled access request and a human classifier kernel may be so calculated.

Where an unlabeled access request, of the group of unlabeled access requests, is determined to be the most-likely of the unlabeled access requests to be human or non-human, based on the applied method of evaluation, the access request may be correspondingly labeled and reported. In an embodiment, labeling of the record with the “closest match” kernel may further include reporting of the corresponding Euclidean distance, on the basis of which the accuracy of the prediction may be estimated. Where the Euclidean distance for a “closest-match” access request is reported, the accuracy of the prediction may be determined based on factors including, without limitation, the distance value, in an embodiment, the distance value relative to other distance values for unlabeled access requests in the same group, in another embodiment, the distance value relative to one or more predefined distance values, and the like, as well as any combination thereof. As an example, according to an embodiment, where accuracy is determined based on comparison of a determined distance value with an expected value, the inaccuracy of the prediction may be equal to the percent difference between the determined distance value and the expected distance value.

FIG. 4 is an example hardware block diagram 400 depicting a classifier 150, according to an embodiment. The classifier 150 includes a processing circuitry 410 coupled to a memory 420, a storage 430, and a network interface 440. In an embodiment, the components of the classifier 150 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized as, for example, flash memory or another memory technology, compact disk-read only memory (CD-ROM), Digital Versatile Disks (DVDs), or any other medium which can be used to store the desired information.

The network interface 440 allows the classifier 150 to communicate with the various components, devices, and systems described herein for differentiating between human and non-human access to computing resources, as well as other, like, purposes.

It should be understood that the embodiments described herein are not limited to the specific architecture illustrated in FIG. 4, and other architectures may be equally used without departing from the scope of the disclosed embodiments.

It should be noted that the computer-readable instructions may be construed broadly to mean any type of instructions, whether referred to as software, firmware, middleware, microcode, hardware description language, or otherwise. Instructions may include code, such as in source code format, binary code format, executable code format, or any other suitable format of code. The instructions, when executed by the circuitry, cause the circuitry to perform the various processes described herein.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (CPUs), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for classifying entities accessing computing resources, comprising:
identifying, within a received request to access a computing resource, at least one data feature, wherein a data feature is a piece of data included in the request and uniquely identifies an entity sending the request;
analyzing each of the at least one identified feature; and
classifying, based on the analysis of the at least one identified data feature, the entity sending the request as any one of: a human, and a non-human.

2. The method of claim 1, wherein identifying at least one data feature further comprises at least one of:
inspecting resource access request contents, inspecting resource access request response contents, and inspecting resources called or invoked during the execution of a process specified in the resource access request.

3. The method of claim 1, wherein classifying the entity sending the request further comprises:
applying dynamic calculations on the results of analyzing the at least one identified data feature.

4. The method of claim 1, wherein analyzing the at least one identified data feature further comprises:
collecting at least one of: a record, and a resource access data feature;
pre-processing the collected record or resource access data feature;
training one or more cluster models;
computing kernel values for the one or more cluster models; and
predicting at least one entity classification.

5. The method of claim 4, further comprising:
statistically normalizing the record;
statistically normalizing the resource access data feature; and
performing a data clean-up process on the record and the resource access data feature.

6. The method of claim 4, wherein training the at least one cluster model further comprises:
training at least one of: a human cluster, and a non-human cluster.

7. The method of claim 4, further comprising:
predicting the at least one entity classification based on a minimum Euclidean distance value, wherein the minimum Euclidean distance value is at least one of: a Euclidean distance value between a human classifier kernel and an unlabeled access request, and a Euclidean distance value between a non-human classifier kernel and an unlabeled access request.

8. The method of claim 7, wherein an unlabeled access request is predicted to be human or non-human based on the kernel closest to the unlabeled access request.

9. The method of claim 1, wherein the at least one data feature is at least a username.

10. A non-transitory computer readable medium having stored thereon instructions for causing a processing circuitry to execute a process for classifying entities accessing computing resources, the process comprising:
identifying, within a received request to access a computing resource, at least one data feature, wherein a data feature is a piece of data included in the request and uniquely identifies an entity sending the request;
analyzing each of the at least one identified feature; and
classifying, based on the analysis of the at least one identified data feature, the entity sending the request as any one of: a human, and a non-human.

11. A system for classifying entities accessing computing resources, comprising:
a processing circuitry; and
a memory, the memory containing instructions that, when executed by the processing circuitry, configure the system to:
identify, within a received request to access a computing resource, at least one data feature, wherein a data feature is a piece of data included in the request and uniquely identifies an entity sending the request;
analyze each of the at least one identified feature; and
classify, based on the analysis of the at least one identified data feature, the entity sending the request as any one of: a human, and a non-human.

12. The system of claim 11, wherein identifying at least one data feature further comprises at least one of:
inspecting resource access request contents, inspecting resource access request response contents, and inspecting resources called or invoked during the execution of a process specified in the resource access request.

13. The system of claim 11, wherein the system is further configured to:
applying dynamic calculations on the results of analyzing the at least one identified data feature.

14. The system of claim 11, wherein the system is further configured to:
collect at least one of: a record, and a resource access data feature;
pre-process the collected record or resource access data feature;
train one or more cluster models;
compute kernel values for the one or more cluster models; and
predict at least one entity classification.

15. The system of claim 14, wherein the system is further configured to:
statistically normalize the record;
statistically normalize the resource access data feature; and
perform a data clean-up process on the record and the resource access data feature.

16. The system of claim 14, wherein the system is further configured to:
train at least one of: a human cluster, and a non-human cluster.

17. The system of claim 14, wherein the system is further configured to:
predict the at least one entity classification based on a minimum Euclidean distance value, wherein the minimum Euclidean distance value is at least one of: a Euclidean distance value between a human classifier kernel and an unlabeled access request, and a Euclidean distance value between a non-human classifier kernel and an unlabeled access request.

18. The system of claim 17, wherein an unlabeled access request is predicted to be human or non-human based on the kernel closest to the unlabeled access request.

19. The system of claim 11, wherein the at least one data feature is at least a username.
